(19) United States
(12) Patent Application Publication
(10) Pub. No.: US 2025/0389390 A1
(43) Pub. Date: Dec. 25, 2025

(54) ASSEMBLY FOR HANDLING, TRANSPORTING AND STORING HYDROGEN, WHEREIN THE ASSEMBLY COMPRISES A COMPONENT COMPRISING A POLYARYLETHERKETONE POLYMER, USE OF SUCH MATERIAL AND METHOD EMPLOYING SUCH MATERIAL

(71) Applicant: VICTREX MANUFACTURING LIMITED, Thornton Cleveleys, Lancashire (GB)

(72) Inventors: Andy Chang, Thornton Cleveleys, Lancashire (GB); Erin Coates, Thornton Cleveleys, Lancashire (GB)

(21) Appl. No.: 19/107,848

(22) PCT Filed: Aug. 29, 2023
(86) PCT No.: PCT/GB2023/052227

§ 371 Date: Feb. 28, 2025

(30) Foreign Application Priority Data
Sep. 2, 2022 (GB) 2212792.2

(51) Int. Cl. F17C 13/02; C08G 65/40

(52) U.S. Cl. CPC F17C 13/02; C08G 65/4012; F17C 2205/0352; F17C 2221/012; F17C 2223/0123; F17C 2223/0161; F17C 2225/0123; F17C 2225/0161

(57) ABSTRACT

There is provided an assembly for handling, transporting storing hydrogen. The assembly comprises a component comprising a polymeric material (A) having a repeat unit of formula I and a repeat unit of formula II wherein Ph represents a phenylene moiety. Also provided are a use of the polymeric material (A) in a component of an assembly for handling, transporting or storing hydrogen and a method of handling, transporting or storing hydrogen. The polymeric material (A) suitably provides the component with advantageously high elongation at break at cryogenic temperatures.

### FIELD

The present invention relates to assemblies for use in hydrogen applications, such as in the handling, transport or storage of hydrogen, in particular compressed or low temperature hydrogen. The assemblies comprise components formed from specific polymers which perform well in contact with hydrogen and at extremely low temperatures. The present invention also relates to the use of a such polymeric materials in a component of an assembly for handling, transporting or storing hydrogen, and to a method of handling, transporting or storing hydrogen.

### BACKGROUND

Hydrogen may be used as a fuel to provide energy without emitting pollutants such as carbon dioxide at the point of use. Hydrogen may also be produced using renewable energy, such as by the electrolysis of water. Therefore hydrogen is anticipated to become a major source of clean energy in the future. However, under ambient conditions gaseous hydrogen has a low energy density. In order to be viable as an energy source, hydrogen must be compressed and/or liquefied, in order to increase its effective energy density. Since hydrogen has a boiling point of −253° C. at atmospheric pressure, the liquefaction of hydrogen involves the use of cryogenic temperatures.

Various steel and non-ferrous alloys have been developed over the years to meet the challenges of property retention in such extremes of low temperature.

As an alternative to metals, polymers may be used in low temperature applications. There are several basic requirements for polymers to function well at very low temperatures—processability and appropriate mechanical properties at both room temperature and low temperature.

In the context of polymers, the main problem with using polymers in cryogenic applications is the very low mobility of polymer chains at such low temperatures which result in low levels of ductility. This issue of low ductility may manifest itself when a part made from a polymeric material (e.g. a valve seat) is subjected to an increasing load. When the incidental load reaches a critical level, a crack may propagate rapidly in the part, even at relatively low energy, leading to failure of the part. Additionally, any surface defects or damage caused during use or manufacture of a polymeric part will act as a stress concentrator which could also lead to rapid and brittle failure in parts having low levels of ductility at the temperature of use.

Commonly used polymers for low temperature applications include PTFE, PCTFE, FEP, polyethylene, polycarbonate, polyimides and various elastomers which have been specially formulated to retain ductility at very low temperatures. However, whilst such polymers may be suitable for some low temperature uses, for other uses, polymers are required which have improved mechanical, abrasion and erosion resistance properties, whilst having excellent chemical resistance properties. It is particularly challenging to find polymers having the required combination of these favourable properties at temperatures where hydrogen is liquid, for example below −253° C.

### SUMMARY OF THE INVENTION

It is one aim of the present invention, amongst others, to provide an assembly, method or use that addresses at least one disadvantage of the prior art, whether identified here or elsewhere, or to provide an alternative to existing assemblies, methods and uses. For instance, it may be an aim of the present invention to provide an assembly which comprises a component formed from a polymeric material which has improved performance at low temperatures and/or in use when contacting hydrogen, than known materials used for forming such components.

According to aspects of the present invention, there is provided an assembly, a method and a use as set forth in the appended claims. Other features of the invention will be apparent from the dependent claims, and from the description which follows.

According to a first aspect of the present invention, there is provided an assembly for handling, transporting or storing hydrogen, wherein the assembly comprises a component comprising a polymeric material (A) having a repeat unit of formula I:

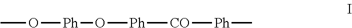

and a repeat unit of formula II:

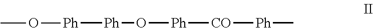

wherein Ph represents a phenylene moiety.

The polymeric material (A) is a polyaryletherketone (PAEK) polymer. More specifically, the polymeric material (A) is a copolymer of poly(ether ether ketone) (PEEK) and poly(ether diphenyl ether ketone) (PEDEK), the repeat units of formula I (which may be referred to as EEK) providing the PEEK polymer component and the repeat units of formula II (which may be referred to as EDEK) providing the PEDEK. Therefore the polymeric material of formula (A) may be referred to as a PEEK/PEDEK copolymer.

The inventors have found that certain polyaryletherketones (PAEKs), in particular the PEEK/PEDEK copolymers as defined herein comprising repeat units of formulas I and II, can be particularly advantageous for hydrogen applications. As shown in the examples below, such polymeric materials may have excellent ductility/elongation at break at cryogenic temperatures, such as below −253° C., whilst maintaining favourable tensile strength, tensile modulus and dimensional stability over a wide temperature range. In particular, the elongation at break of such polymeric materials (A) has surprisingly been shown to be significantly superior to fluoropolymers such as PCTFE at temperatures below −253° C. and also to other PEEK polymeric materials (see FIG. 10). Improved ductility is particularly important for components of such an assembly for handling, transporting or storing hydrogen, which need to be able to tolerate high loads and withstand some plastic deformation without breakage when the component and assembly are cooled to extremely low temperatures under high pressures and high mechanical stress in use. As discussed above, many polymers have less than ideal ductility at cryogenic temperatures, particular when used to withstand high loads and stresses, for example due to high pressure. The polymeric material (A) may therefore provide performance improvements in an assembly of the present invention.

The polymeric material (A) advantageously achieves this improved elongation at break at such low temperatures whilst maintaining a similar, favourable tensile strength and tensile modulus to the currently used fluoropolymers such as PCTFE.

Furthermore, the polymeric materials of the present invention may advantageously provide lubricity, even when used with cryogenic fluids which are typically not good lubricators. This is particularly important for moving parts such as impellers.

Furthermore, the polymeric materials of the present invention may have low hydrogen permeability, and therefore help to prevent hydrogen leakage from such an assembly, especially compared to fluoropolymers such as PTFE.

Furthermore, the manufacture of such PAEK components has several advantages over the manufacture of corresponding components from other materials. PAEKs may be manufactured by melt processing (e.g. molding or extrusion processes) which allows their fabrication into long continuous parts, such as pipes. This is not possible for certain fluoropolymers such as PTFE and PCTFE which can only be compression moulded or sintered. PAEK can be used in additive manufacturing resulting in low porosity components having good mechanical properties and allowing the manufacture of components having complex shapes.

Known methods for making such components with complex shapes are metal subtractive manufacturing and metal additive manufacturing. Metal subtractive manufacturing may be time consuming and wasteful, whilst metal additive manufacturing tends to result in low porosity structures. Therefore making such components from the PAEK materials disclosed herein may improve the efficiency of manufacture of these components compared to these known methods. In addition, the milder conditions used in PAEK manufacture allows the incorporation of delicate components such as electronics during the melt processing step.

### The Polymeric Material (A)

The polymeric material (A) is suitably crystalline and generally has a crystalline melting point which is below that of the homopolymer of repeating unit I or the homopolymer of repeating unit II. However, the glass transition temperature of the polymeric material (A) is generally the same as, or slightly higher than, the glass transition temperature of the homopolymer of repeating unit I. More specifically, the polymeric material (A) suitably has a glass transition temperature of greater than 143° C. and up to 160° C., and a crystalline melting temperature of 300° C. and up to 330° C. In particular, a polymer containing repeating units I and II in the relative proportions of 80:20 has a glass transition temperature of about 149° C. and a crystalline melting temperature of about 309° C.

The phenylene moieties (Ph) in each repeat unit may independently have 1,4-para linkages to the atoms to which they are bonded or 1,3-meta linkages. Where a phenylene moiety includes 1,3-linkages, the moiety will be in the amorphous phase of the polymer. Crystalline phases will include phenylene moieties with 1,4-linkages. In many applications it is preferred for the polymeric material to be highly crystalline and, accordingly, the polymeric material preferably includes high levels of phenylene moieties with 1,4-linkages.

Suitably at least 95% or at least 99%, of the number of phenylene moieties (Ph) in the repeat unit of formula I have 1,4-linkages to the moieties to which they are bonded. It is especially preferred that each phenylene moiety in the repeat unit of formula I has 1,4-linkages to the moieties to which it is bonded.

Suitably at least 95% or at least 99%, of the number of phenylene moieties (Ph) in the repeat unit of formula II have 1,4-linkages to the moieties to which they are bonded. It is especially preferred that each phenylene moiety in the repeat unit of formula II has 1,4-linkages to the moieties to which it is bonded.

Preferably, the phenylene moieties in the repeat units of formula I are unsubstituted. Preferably, the phenylene moieties in the repeat units of formula II are unsubstituted.

The repeat unit of formula I suitably has the structure Ia:

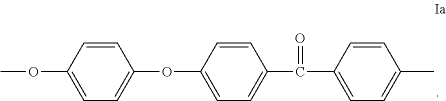

The repeat unit of formula II suitably has the structure IIa:

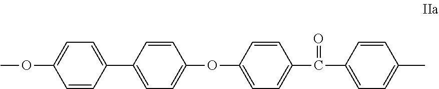

Preferably, the repeat unit of formula I has the structure Ia and the repeat unit of formula II has the structure IIa.

The polymeric material (A) may include at least 68 mol %, preferably at least 71 mol % of repeat units of formula I. Particular advantageous polymeric materials (A) may include at least 72 mol %, or, especially, at least 74 mol % of repeat units of formula I. The polymeric material (A) may include less than 95 mol % or less than 90 mol %, suitably 82 mol % or less of repeat units of formula I. The polymeric material (A) may include 68 to 82 mol %, preferably 70 to 80 mol %, more preferably 72 to 77 mol % of units of formula I.

The polymeric material (A) may include at least 10 mol %, preferably at least 18 mol %, of repeat units of formula II. The polymeric material (A) may include less than 32 mol %, preferably less than 29 mol % of repeat units of formula II. Particularly advantageous polymeric materials (A) may include 28 mol % or less; or 26 mol % or less of repeat units of formula II. The polymeric material (A) may include 18 to 32 mol %, preferably 20 to 30 mol %, more preferably 23 to 28 mol % of units of formula II.

The sum of the mol % of units of formula I and II in the polymeric material (A) is suitably at least 95 mol %, is preferably at least 98 mol %, is more preferably at least 99 mol % and, especially, is about 100 mol %.

In some embodiments, the polymeric material (A) contains repeat units I and II in the molar proportions I:II of from 60:40 to 90:10 or of from 70:30 to 80:20.

Typically, the polymeric material (A) will have end units of the polymer which may be the same as the repeat units, but with a terminal OH or F group. However, the process for forming the polymer may include a separate end-capping step at completion of polymerisation, in which case a separate monomer or reagent may be added as an end-capping agent so that the end units may differ from the repeat units of the polymer. Such end-capping is well known in the field of nucleophilic polycondensation reactions.

The polymeric material of formula (A) may have a melt viscosity (MV) of at least 0.06 kN·s·m⁻² and more preferably of at least 0.10 kN·s·m⁻². Suitably the polymeric material (A) has an MV of at least 0.20 kN·s·m⁻².

Suitably, the polymeric material has an MV of up to 1.80 kN·s·m⁻², up to 1.50 kN·s·m⁻² or up to 1.00 kN·s·m⁻².

Suitably the polymeric material (A) has an MV of from 0.06 to 1.80 kN·s·m⁻², from 0.10 to 1.50 kN·s·m⁻²or from 0.20 to 1.00 kN·s·m⁻².

In some embodiments, the polymeric material (A) has an MV of from 0.20 to 0.50 kNsm⁻², or from 0.25 to 0.40 kNsm⁻².

The melt viscosity (MV) may be measured, unless otherwise stated herein, using capillary rheometry at 400° C. at a shear rate of 1000 s⁻¹ by extrusion through a tungsten carbide capillary die of 0.5 mm diameter and 8.0 mm length.

The melt viscosity of the polymeric material may be measured by capillary rheometry using an RH10 capillary rheometer (Malvern Instruments Rosand RH10 capillary rheometer), fitted with a tungsten carbide die, 0.5 mm (capillary diameter)×8.0 mm (capillary length). Approximately 5 grams of the polymeric material is dried in an air circulating oven for 3 hours at 150° C. The extruder is allowed to equilibrate to 400° C. The dried polymeric material is loaded into the heated barrel of the extruder, a brass tip (12 mm long×9.92+0.01 mm diameter) placed on top of the polymer followed by the piston and the screw manually turned until the proof ring of the pressure gauge just engages the piston to help remove any trapped air. The column of polymeric material is allowed to heat and melt over a period of at least 5 minutes. After the preheat stage the screw is in motion so that the melted polymeric material is extruded through the die to form a thin fibre at a shear rate of 1000 s⁻¹, while recording the pressure (P) required to extrude the polymeric material. The Melt Viscosity is given by the formula:

$$Melt Viscosity = \underline{P π {r}^{4}} {kNsm}^{- 2}$$

$$8 L S A$$

$$where P = Pressure / kN {m}^{- 2}$$

$$L = Length of die / m$$

$$S = ram speed / m {s}^{- 1}$$

$$A = barrel cross - sectional area / {m}^{2}$$

$$r = Die radius / m$$

The relationship between shear rate and the other parameters is given by the equation:

Apparent wall shear rate=4Q/πr³

where Q=volumetric flow rate/m³s⁻¹=SA.

Suitable polymeric materials (A) may be prepared by polycondensation of monomers containing carbonyl chloride groups in the presence of Friedel Crafts reagents or by polycondensation of phenolic compounds with halo-compounds in the presence of an alkaline reagent.

More specifically, a suitable polymeric material (A) may be obtained by the polycondensation of a mixture of at least one dihydroxybenzene compound and at least one dihydroxybiphenyl compound with at least one dihalobenzophenone. Preferably hydroquinone; 4,4′-dihydroxybiphenyl and 4,4′-difluorobenzophenone are used as the monomers. Polycondensation is preferably effected in the presence of an alkali metal carbonate or bicarbonate, or a mixture thereof. The polymerisation is preferably effected in the presence of a polymerisation solvent such as an aryl sulphone.

Further suitable polymeric materials of formula (A) (PEEK/PEDEK copolymers) and methods of preparing them are as described in U.S. Pat. No. 4,717,761, WO 2014/207458 A1 and WO 2015/124903 A1, the contents of which are incorporated herein by reference.

WO 2014/207458 A1 discloses PEEK/PEDEK copolymers, which have repeat units of formula I and II in a molar proportion from 55:45 to 95:5 and with an MV measured at 340° C. and 1000 s⁻¹ shear rate of at least 0.25 kNsm⁻² and less than 1.2 kNsm⁻².

WO 2015/124903 A1 discloses PEEK/PEDEK copolymers which have repeat units of formula I and II in a molar ratio from 55:45 to 95:5 and an MV of at least 0.25 and less than 1.2 measured at 340° C. and at 1000 s⁻¹ shear rate.

In some embodiments, the polymeric material (A) may be as described in WO 2022013520 A1, the contents of which are incorporated herein by reference. In such embodiments, the polymeric material (A) may consist essentially of repeat units of formula I:

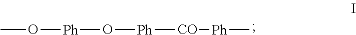

repeat units of formula IIa:

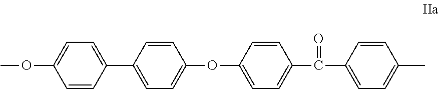

and end units;
wherein the molar ratio of repeat units of formula I to repeat units of formula IIa is from 55:45 to 95:5; and
wherein the repeat units of formula I consist essentially of 50 to 90 molar % of repeat units of formula Ia:

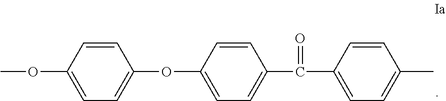

and 10 to 50% molar % of repeat units which are of formula Ib, of formula Ic or of a mixture thereof;
wherein the repeat unit of formula Ib is:

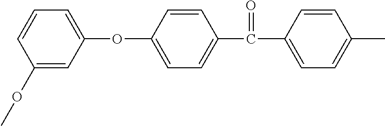

Ib; and
the repeat unit of formula Ic is:

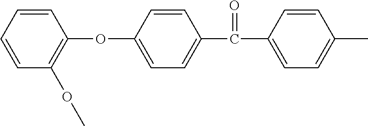

Ic.

Preferably, the molar ratio of repeat units of formula I to repeat units of formula IIa is from 60:40 to 90:10, preferably from 70:30 to 90:10, more preferably from 80:20 to 90:10.

The repeat units of formula I consist essentially of, or preferably consist of, 50 to 90 molar % of repeat units of formula Ia in combination with 10 to 50 molar % of repeat units of formula Ib and/or formula Ic. Preferably the repeat units of formula I consist essentially of, or preferably consist of, 65 to 90% molar % of repeat units of formula la in combination with 10 to 35 molar % of repeat units which are of formula Ib, of formula Ic, or of a mixture thereof. More preferably, the repeat units of formula I consist essentially of, or preferably consist of, 80 to 90% molar % of repeat units of formula la in combination with 10 to 20 molar % of repeat units which are of formula Ib, of formula Ic, or of a mixture thereof.

The repeat units Ia are referred to as R_{PEEK}, the repeat units Ib are referred to as R_{mPEEK} and the repeat units Ic are referred to as R_{oPEEK}.

So, in other words, the repeat units of formula I have, expressed as molar proportions:
R_{PEEK}:(R_{mPEEK}+R_{oPEEK}) from 90:10 to 50:50, preferably from 90:10 to 65:35, more preferably from 90:10 to 80:20.

In a preferred embodiment, the polymeric material (A) is a copolymer as described above wherein the molar ratio of repeat units of formula I to repeat units of formula II is from 90:10 to 80:20 and wherein the repeat units of formula I consist essentially of, or preferably consist of, 80 to 90 molar % of repeat units of formula Ia in combination with 10 to 20 molar % of repeat units which are of formula IIb, of formula Ic, or of a mixture thereof.

It will be understood that formula I: —O—Ph—O—Ph—CO—Ph— provides no information concerning whether the ether linkages on the —O—Ph—O— moiety are arranged in para-, meta- or ortho-configuration, whereas this is specified for formulae Ia, Ib and Ic, as are all other configurations within the repeat units.

In one embodiment, the copolymer according to the first aspect of the invention may be a copolymer which does not include repeat units of formula Ib.

In another embodiment, the copolymer according to the first aspect of the invention may be a copolymer which does not include repeat units of formula Ic.

### The Component and Assembly

In some embodiments, the polymeric material (A) provides up to 100 wt % of the component, suitably up to 95 wt % or up to 90 wt % of the component. The polymeric material (A) may provide at least 40 wt %, suitably at least 50 wt %, at least 70 wt %, at least 80 wt % or at least 85 wt % of the component. Suitably the polymeric material (A) provides from 70 to 100 wt % of the component, from 80 to 100 wt % or from 85 to 100 wt % of the component.

Suitably the component consists essentially or consists of the polymeric material (A) as defined above.

The assembly of this first aspect may be subjected to a temperature between −260° C. and 250° C., or between −254° C. and 65° C. The assembly of this first aspect may be subjected to a temperature of less than −200° C. in use. The assembly may be subjected to a temperature of less than −230° C., such as less than −250° C., for example less than −253° C. in use. The assembly of this first aspect may be subjected to a temperature in the range of −300° C. to −200° C., such as −280° C. to −200° C. or −260° C. to −200° C. or −253° C. to −200° C.

The assembly may be associated with the handling, transport or storage of compressed hydrogen or liquid hydrogen. Compressed hydrogen suitably has a pressure from 10 to 100 MPa (i.e. 100 to 1000 bar), such as from 20 to 85 MPa (i.e. 200 to 850 bar), for example from 35 to 70 MPa (i.e. 350 to 700 bar). Suitably, the assembly is associated with the handling, transport or storage of liquid hydrogen. The component may come into contact with hydrogen, such as compressed hydrogen or liquid hydrogen, in use. Suitably the component of the assembly is a hydrogen-contacting component. Suitably the polymeric material (A) of the component comes into contact with the hydrogen, in use of the assembly. The component suitably comprises a hydrogen-contacting surface or layer which comprises the polymeric material (A). Suitably the polymeric material (A) provides such a hydrogen-contacting surface or layer of the component.

The assembly may comprise at least two components as described herein, which comprise the polymeric material (A), suitably as a hydrogen-contacting surface or layer of the component.

The component is suitably selected from a seal, a valve, a part of a valve, a gasket, a bearing, a part of a bearing, a housing, a ring, an impeller, a storage vessel, a part of a storage vessel, a pipe, a part of a pipe, a pipe liner, a connector, insulation, for example for wire or cable, a bush, an umbilical, and a part of an umbilical.

The component may be a seal, such as a valve seat. The component may be a ring, such as a piston ring or a piston rod ring. The component may be a part of a valve, such as a part of a valve for a hydrogen compressor. The component may be part of a hydrogen compressor such as a part of a compressor including piston rings, piston rod rings, valve plates, or packing case.for a hydrogen compressor. The component may be an impeller, such as an impeller for a hydrogen liquefier. Suitably, the component is a piston ring, a piston rod ring, or an impeller.

The component may be an umbilical or a part of an umbilical, such as an umbilical sheath. The umbilical may be for use in subsea or subterranean installations. The umbilical suitably comprises an umbilical sheath and one or more conduits, preferably two or more conduits. The umbilical sheath is suitably in the form of a pipe. The umbilical sheath may consist essentially of the polymeric material (A). Alternatively, the umbilical sheath may further comprise a metal, such as steel, suitably in the form of wires or cables. The umbilical sheath may comprise an outer sheath comprising the polymeric material (A), an intermediate sheath comprising the metal, preferably metal wires or cables, and an inner sheath comprising the polymeric material (A). The conduits enable transmission of material, energy or information through the umbilical. Examples of suitable conduits include pipes for the transmission of fluids, such as hydrogen, sensors, transducers and transmitting devices such as electrical cables, fibre optic cables, and antennae. Preferably, the umbilical comprises a pipe for the transmission of hydrogen, such as compressed hydrogen or liquid hydrogen, and at least one other conduit.

The component may comprise a sensor and/or a transducer. Suitably, the component is a pipe or storage vessel and comprises a sensor and/or transducer. The sensor and/or transducer may be incorporated into the polymeric material (A), for example during melt processing. This advantageously allows the flow of hydrogen in the pipe or storage vessel to be monitored, measured and/or controlled. Suitably, the component consists essentially of the polymeric material (A) and the sensor and/or transducer. The absence of metal or electrically conductive additives such as carbon fibres advantageously allows electromagnetic radiation to be transmitted through the polymeric material (A) to or from the sensor and/or the transducer.

The component may be a storage vessel, such as a tank. In this embodiment, the tank may have a liner, preferably wherein the liner comprises or is formed of a polyaryletherketone (PAEK). Preferably, the liner of the tank comprises or is formed of PEEK.

The component may be part of a storage vessel, such as part of a tank. Preferably, the component is a liner for a storage vessel, such as a tank. In this embodiment, when the component is a liner for a storage vessel, the storage vessel may comprise or be formed of polymeric material (A),

The component may be an umbilical sheath comprising a sensor and/or a transducer as described above. In such an embodiment, the umbilical sheath suitably consists essentially of the polymeric material (A) and the sensor and/or transducer.

### Composite Components

In some embodiments, the component may comprise additional material, for example a filler material. The component may be provided by a composite material comprising the polymeric material (A) and a filler material.

The filler material may include a fibrous filler or a non-fibrous filler. The filler material may include both a fibrous filler and a non-fibrous filler. The fibrous filler may be continuous or discontinuous.

The fibrous filler may be selected from inorganic fibrous materials, non-melting and high-melting organic fibrous materials, such as aramid fibres, and carbon fibre.

The fibrous filler may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibrous fillers are glass fibre and carbon fibre.

The fibrous filler may comprise nanofibres.

The non-fibrous filler may be selected from mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulfate. The non-fibrous fillers may be introduced in the form of powder or flaky particles.

The composite material may be prepared as described in Impregnation Techniques for Thermoplastic Matrix Composites. A Miller and A G Gibson, Polymer & Polymer Composites 4(7), 459-481 (1996), EP102158 and EP102159, the contents of which are incorporated herein by reference. Preferably, in the method, the polymeric material (A) and the filler material are mixed at an elevated temperature, suitably at a temperature at or above the melting temperature of the polymeric material (A). Therefore, the polymeric material (A) and filler material are suitably mixed whilst the polymeric material (A) is molten. Said elevated temperature is suitably below the decomposition temperature of the polymeric material (A). Said elevated temperature is preferably at or above the main peak of the melting endotherm (Tm) for said polymeric material (A). Said elevated temperature is preferably at least 300° C. Advantageously, the molten polymeric material (A) can readily wet the filler and/or penetrate consolidated fillers, such as fibrous mats or woven fabrics, so the composite material prepared comprises the polymeric material (A) and filler material which is substantially uniformly dispersed throughout the polymeric material (A).

The composite material may be prepared in a substantially continuous process. In this case polymeric material (A) and filler material may be constantly fed to a location wherein they are mixed and heated. An example of such a continuous process is extrusion. Another example (which may be particularly relevant wherein the filler material comprises a fibrous filler) involves causing a continuous filamentous mass to move through a melt or aqueous dispersion comprising the polymeric material (A). The continuous filamentous mass may comprise a continuous length of fibrous filler or, more preferably, a plurality of continuous filaments which have been consolidated at least to some extent. The continuous fibrous mass may comprise a tow, roving, braid, woven fabric or unwoven fabric. The filaments which make up the fibrous mass may be arranged substantially uniformly or randomly within the mass. A composite material could be prepared as described in PCT/GB2003/001872, U.S. Pat. No. 6,372,294 or EP1215022, which are incorporated herein by reference.

Alternatively, the composite material may be prepared in a discontinuous process. In this case, a predetermined amount of the polymeric material (A) and a predetermined amount of the filler material may be selected and contacted, and a composite material prepared by causing the polymeric material (A) to melt and causing the polymeric material (A) and filler material to mix to form a substantially uniform composite material.

Preferably, the filler material comprises one or more fillers selected from glass fibre, carbon fibre, carbon black and a fluorocarbon resin. More preferably, the filler material comprises glass fibre or carbon fibre.

The composite material may include from 20 to 99.9 wt % or from 20 to 70 wt % of the polymeric material (A) and from 0.1 to 80 wt % or from 30 to 80 wt % of the filler material. Preferred embodiments include greater than 10 wt %, more preferably greater than 40 wt % of the filler material.

The composite material may be a fibre-reinforced unidirectional tape (UD tape) comprising the polymeric material (A) and a fibrous filler material as described above.

In some embodiments, the component comprises a further polymeric material and/or a composite material and/or a metal. The further polymeric material is suitably not a polymeric material (A) as described above. The further polymeric material and/or composite material and/or the metal suitably provides strength and/or bulk to the component.

### Layered Components

The polymeric material (A) may be bonded to a further polymeric material and/or composite material and/or metal. The polymeric material (A) and the further polymeric material and/or composite material and/or metal may be in the form of layers, preferably bonded to one another.

The component may be a pipe or a storage vessel comprising a layer comprising the polymeric material (A) and a layer comprising the further polymeric material and/or composite material and/or metal. The layer comprising the polymeric material (A) does not comprise the further polymeric material and/or a composite material and/or a metal. The layer comprising the further polymeric material and/or composite material and/or metal does not comprise the polymeric material (A).

Suitably the layer comprising the polymeric material (A) is a hydrogen-contacting surface or layer of the component.

The pipe or storage vessel may comprise an inner layer comprising the polymeric material (A) and an outer layer comprising the further polymeric material and/or composite material and/or metal. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm. In such embodiments, the inner layer is suitably a hydrogen-contacting layer of the pipe or storage vessel.

The pipe or storage vessel may comprise an outer layer comprising the polymeric material (A) and an inner layer comprising the further polymeric material and/or composite material and/or metal. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm.

The pipe or storage vessel may comprise at least two layers comprising the polymeric material (A) and at least one layer comprising the further polymeric material and/or composite material and/or metal. The layer comprising the further polymeric material and/or composite material and/or metal may be arranged between two layers comprising the polymeric material (A). The pipe or storage vessel may comprise an outer layer comprising the polymeric material (A), an intermediate layer comprising the further polymeric material and/or composite material and/or metal, and an inner layer comprising the polymeric material (A). Suitably, the total volume of the metal in the pipe or storage vessel is less than the total volume of the polymeric material (A). The total volume of the polymeric material (A) is suitably at least 2 times, such as at least 3 times, for example at least 4 times greater than the total volume of the further polymeric material and/or composite material and/or metal.

### Layered Component Comprising Further Polymeric Material

In some embodiments, the component comprises the further polymeric material. Therefore in such embodiments the component comprises the polymeric material (A) and the further polymeric material.

The further polymeric material may provide a strong, lightweight replacement for metal.

The further polymeric material may be a polyaryletherketone (PAEK), suitably a PEEK polymer. The further polymeric material may be a polymeric material (B) having a repeat unit of formula I:

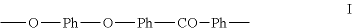

wherein Ph represents a phenylene moiety.

Suitably at least 95%, or at least 99%, of the number of phenylene moieties (Ph) in polymeric material (B) have 1,4-linkages to the moieties to which they are bonded. It is especially preferred that each phenylene moiety in polymeric material (B) has 1,4-linkages to the moieties to which it is bonded.

Suitably the phenylene moieties in repeat unit of formula I are unsubstituted.

The polymeric material (B) may include at least 68 mol %, preferably at least 71 mol %, of repeat units of formula Ia:

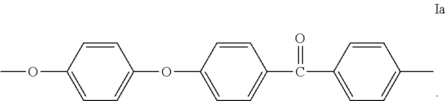

Suitably the polymeric material (B) includes at least 80 mol %, preferably at least 90 mol %, more preferably at least 95 mol %, especially at least 99 mol % of repeat units of formula I, especially those of formula la. Therefore the polymeric material (B) is preferably a homopolymer, which is preferably a polyetheretherketone (PEEK).

Suitable PEEK polymeric materials are available from Victrex Ltd.

In some embodiments, the polymeric material (B) does not comprise a repeat unit of formula II. Suitably the polymeric material (B) has a melt viscosity of at least 0.38 kNsm⁻².

A suitable polymeric material (B) having a melt viscosity (MV) of at least 0.38 kNsm⁻² may be prepared as described in EP3274394, the contents of which are incorporated herein by reference. The polymeric material (B) may be prepared by heating a mixture of 2-fluorobenzoyl chloride, fluorobenzene and anhydrous aluminium trichloride to obtain 4,4′-difluorobenzophenone (BDF). A mixture of said 4,4′-difluorobenzophenone and hydroquinone, diphenylsulphone, dried sodium carbonate and potassium carbonate may be heated to produce a polymeric material (B). The reaction mixture may be heated until the required melt viscosity is reached.

An example of a suitable polymeric material (B) is VICTREX CT™ 100, which is commercially available from Victrex Manufacturing Limited.

### Layered Component Comprising Composite Material

In some embodiments, the component comprises the composite material. Therefore in such embodiments the component comprises the polymeric material (A) and the composite material, suitably in different layers of the component.

The composite material may provide a strong, lightweight replacement for metal.

The composite material suitably comprises a polymeric material (B) as defined above and a filler material, as defined above.

The composite material may be a fibre-reinforced unidirectional tape (UD tape) comprising the polymeric material (B) and a fibrous filler material as described above.

The polymeric material (A) may be bonded to the composite material. The polymeric material (A) and the composite material may be in the form of layers, preferably bonded to one another.

The combination of a layer of the polymeric material (A) and a layer of the composite material advantageously minimises stress between the layers when the temperature is decreased, which might otherwise cause failure of the component, for example by cracking or delamination.

The component may be a pipe or storage vessel comprising a layer comprising the polymeric material (A) and a layer comprising the composite material. The layer comprising the polymeric material (A) suitably does not comprise a composite material.

The pipe or storage vessel may comprise an inner layer comprising the polymeric material (A) and an outer layer comprising the composite material. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm. The smaller the thickness of the liner, the greater the reduction in stress between the layers.

The pipe or storage vessel may comprise an inner layer comprising the composite material and an outer layer comprising the polymeric material (A). The layers may otherwise be as described above.

### Layered Component Comprising a Metal

In some embodiments, the component comprises the metal. Therefore in such embodiments the component comprises the polymeric material (A) and the metal.

The metal may comprise a ferrous metal and/or a non-ferrous metal. The metal may comprise an alloy. The metal may comprise steel, titanium, aluminium, an alloy of aluminium, or copper. The metal may be steel, titanium, aluminium, an alloy of aluminium, or copper.

The metal may provide strength to the component. However, metals are heavy and reduce the flexibility of the component. Further, metals such as high strength steels, titanium and aluminium alloys may be susceptible to hydrogen embrittlement. This is a process by which metals become brittle and fracture due to the ingress and diffusion of hydrogen. This can lead to a substantial reduction in ductility and load bearing capacity of the metal and therefore the component. The combination of the polymeric material (A) and the metal allows the weight of the component to be reduced while increasing its flexibility and maintaining its strength. Furthermore, the polymeric material (A) may have low hydrogen permeability and protect the metal from exposure to hydrogen.

The polymeric material (A) may be bonded to the metal. The polymeric material may be part of a composite material as described herein. The polymeric material (A) or composite material comprising the polymeric material (A) and the metal may be in the form of layers, preferably bonded to one another.

The component may be a pipe or storage vessel comprising a layer comprising the polymeric material (A) and a layer comprising the metal.

The pipe or storage vessel may comprise an outer layer comprising the metal and an inner layer comprising the polymeric material (A). Suitably the metal is susceptible to hydrogen embrittlement. The metal may comprise steel (such as a high strength steel), titanium or an aluminium alloy. The low hydrogen permeability of the polymeric material (A) may advantageously protect the outer layer from hydrogen embrittlement and prevent leakage of hydrogen when hydrogen is present in the pipe or storage vessel. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm.

The pipe or storage vessel may comprise an outer layer comprising the polymeric material (A) and an inner layer comprising the metal. Suitably the metal is hydrogen-resistant. The metal may comprise aluminium or copper. The inner layer may advantageously prevent hydrogen from leaking from the pipe or storage vessel, while the outer layer provides toughness to the pipe or storage vessel. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm.

The pipe or storage vessel may comprise at least two layers comprising the polymeric material (A) and at least one layer comprising the metal. Suitably the metal is hydrogen-resistant. The metal may comprise aluminium or copper. The layer comprising the metal may advantageously prevent hydrogen from leaking from the pipe or storage vessel, while the layers comprising the polymeric material (A) provide toughness to the pipe or storage vessel. The layer comprising the metal may be arranged between two layers comprising the polymeric material (A). The pipe or storage vessel may comprise an outer layer comprising the polymeric material (A), an intermediate layer comprising the metal, and an inner layer comprising the polymeric material (A). Suitably, the total volume of the metal in the pipe or storage vessel is less than the total volume of the polymeric material (A). The total volume of the polymeric material (A) is suitably at least 2 times, such as at least 3 times, for example at least 4 times greater than the total volume of the metal. The smaller the relative volume of the metal in the pipe or storage vessel, the greater the flexibility of the pipe or storage vessel.

Suitably, the polymeric material (A) is bonded to the metal. Some polymeric materials, when bonded together, may be susceptible to interfacial stress at very low temperatures due to differences in the coefficient of thermal expansion (CTE) of the polymer and the metal. This can cause failure or disbondment of the component. The polymeric material (A) may advantageously have a lower interfacial stress with the metal compared to known components comprising a metal and a polymeric material, therefore improving the bond between the metal and the polymeric material at low temperatures,.

In some embodiments, the component comprises polymeric material (A), polymeric material (B) and the metal.

The polymeric material (B) is suitably bonded to the polymeric material (A).

The component may comprise the polymeric material (A), the polymeric material (B), and the metal as defined herein. The polymeric material (A) may advantageously improve the compatibility of the polymeric material (B) with the metal, in particular at very low temperatures.

Preferably, the polymeric material (B) does not comprise repeat units of formula II. Preferably, the metal comprises steel. Preferably, the polymeric material (B) is a PEEK polymer and the metal is steel.

The polymeric material (A), the polymeric material (B), and the metal may each be in the form of a layer. The component may be a pipe or storage vessel comprising a layer comprising the polymeric material (A), a layer comprising the polymeric material (B), and a layer comprising the metal.

Suitably, the polymeric material (A) is bonded to the metal and to the polymeric material (B). Preferably the polymeric material (B) is not bonded to the metal. Suitably, the layer comprising the polymeric material (A) is arranged between the layer comprising the polymeric material (B) and the layer comprising the metal. The polymeric material (B) and the metal, when bonded together, may be susceptible to interfacial stress at very low temperatures due to differences in the coefficient of thermal expansion (CTE) of the polymeric material (B) and the metal. This can cause failure or disbondment of the component. The polymeric material (A) may advantageously reduce the interfacial stress between the polymeric material (B) and the metal, by bonding to both the layer comprising the polymeric material (B) and the layer comprising the metal and therefore avoiding the layer comprising the polymeric material (B) and the layer comprising the metal contacting each other and causing the potential problems discussed above.

The component may be a pipe or storage vessel comprising an inner layer comprising the polymeric material (B), a middle layer comprising the polymeric material (A), and an outer layer comprising the metal. Alternatively, the component may be a pipe or storage vessel comprising an inner layer comprising the metal, a middle layer comprising the polymeric material (A), and an outer layer comprising the polymeric material (B).

According to a further aspect of the present invention, there is provided a component as defined in the first aspect which is associated with handling, transport or storage of hydrogen, suitably liquid hydrogen.

According to a second aspect of the present invention, there is provided a use of a polymeric material (A) in a component of an assembly for handling, transporting or storing hydrogen, wherein the polymeric material (A) has a repeat unit of formula I:

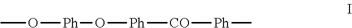

and a repeat unit of formula II:

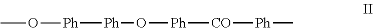

wherein Ph represents a phenylene moiety.

The polymeric material (A) may have any of the suitable features or advantages described in relation to the first aspect.

In the use of this second aspect, the assembly and the component may be as described in relation to the first aspect.

Suitably in the use of this second aspect, the component comes into contact with the hydrogen, suitably as compressed hydrogen or liquid hydrogen. Suitably the polymeric material (A) of the component comes into contact with the hydrogen.

Suitably the use of this second aspect is for improving the tensile strength and/or elongation at break at cryogenic temperatures, such as at −253° C. or below, of the component in the assembly during handling, transporting or storing hydrogen, suitably liquid hydrogen. Suitably the use of this second aspect is for improving the elongation at break of the component at such temperatures. The tensile strength and elongation at break are suitably measured as described in the examples below. The improvement is suitably relative to the same component where the polymeric material (A) is replaced by a fluoropolymer, such as PCTFE.

Suitably the use of this second aspect is for reducing the hydrogen permeability of the component in the assembly during handling, transporting or storing hydrogen.

Suitably the use of this second aspect is for reducing or preventing hydrogen embrittlement of the component in the assembly during handling, transporting or storing hydrogen, suitably wherein the component comprises a metal such as steel. In such embodiments, the polymeric material (A) is provided as a hydrogen-contacting layer or surface which prevents the metal of the component from contacting the hydrogen, during use of the assembly.

In the use of this second aspect, the assembly is suitably subjected to a temperature between −260° C. and 250° C., or between −254° C. and 65° C. The assembly of this second aspect may be subjected to a temperature of less than −200° C. in use. The assembly may be subjected to a temperature of less than −230° C., such as less than −250° C., for example less than −253° C. in use. The assembly of this first aspect may be subjected to a temperature in the range of −300° C. to −200° C., such as −280° C. to −200° C. or −260° C. to −200° C. or −253° C. to −200° C.

In the use of this second aspect, the assembly is suitably for handling, transporting or storing compressed hydrogen having a pressure from 10 to 100 MPa (i.e. 100 to 1000 bar), such as from 20 to 85 Mpa (i.e. 200 to 850 bar), for example from 35 to 70 Mpa (i.e. 350 to 700 bar). Suitably, the compressed hydrogen is liquid hydrogen.

According to a third aspect of the present invention, there is provided a method of handling, transporting or storing hydrogen, the method comprising:
(i) providing a component in an assembly for handling, transporting or storing hydrogen, wherein the component comprises a polymeric material (A), wherein the polymeric material (A) has a repeat unit of formula I:

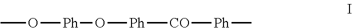

and a repeat unit of formula II:

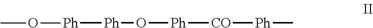

wherein Ph represents a phenylene moiety, and
(ii) contacting the assembly with hydrogen so as to handle, transport or store the hydrogen.

The polymeric material (A) may have any of the suitable features or advantages described in relation to the first and second aspects.

In the method of this third aspect, the assembly and the component may be as described in relation to the first aspect.

Suitably in the method of this third aspect, the component is contacted with hydrogen, suitably as compressed hydrogen or liquid hydrogen. Suitably the polymeric material (A) of the component is contacted with the hydrogen.

In the method of this third aspect, the assembly is suitably subjected to a temperature between −260° C. and 250° C., or between −254° C. and 65° C. The assembly of this third aspect may be subjected to a temperature of less than −200° C. in use. The assembly may be subjected to a temperature of less than −230° C., such as less than −250° C., for example less than −253° C. in use. The assembly of this first aspect may be subjected to a temperature in the range of −300° C. to −200° C., such as −280° C. to −200° C. or −260° C. to −200° C. or −253° C. to −200° C.

In the method of this third aspect, the assembly is suitably contacted with compressed hydrogen having a pressure from 10 to 100 Mpa (i.e. 100 to 1000 bar), such as from 20 to 85 Mpa (i.e. 200 to 850 bar), for example from 35 to 70 Mpa (i.e. 350 to 700 bar). Suitably, the compressed hydrogen is liquid hydrogen.

According to a fourth aspect of the present invention, there is provided a component comprising a polymeric material (A), a polymeric material (B), and a metal, wherein the polymeric material (A) is bonded to the metal and to the polymeric material (B);
wherein the polymeric material (A) has a repeat unit of formula I:

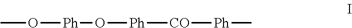

and a repeat unit of formula II:

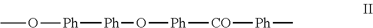

wherein Ph represents a phenylene moiety, and
wherein the polymeric material (B) has a repeat unit of formula I:

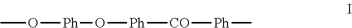

and does not comprise a repeat unit of formula II:

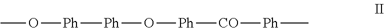

wherein Ph represents a phenylene moiety.

Such a component comprising a polymeric material (A), a polymeric material (B), and a metal is described in relation to the first aspect. The polymeric material (A), polymeric material (B) and metal of the component of this fourth aspect may have any of the suitable features and advantages, where appropriate, as described in relation to the first aspect.

The component of this fourth aspect is suitably a component of an assembly for handling, transporting or storing hydrogen. The component is suitably intended to come into contact with hydrogen, such as compressed hydrogen or liquid hydrogen, in use. Suitably the component is a hydrogen-contacting component, as described in relation to the first aspect.

The polymeric material (A), the polymeric material (B), and the metal may each be in the form of a layer. The component may be a pipe or storage vessel comprising a layer comprising the polymeric material (A), a layer comprising the polymeric material (B), and a layer comprising the metal.

According to a fifth aspect of the present invention, there is provided a method of making a component comprising a polymeric material (A), a polymeric material (B), and a metal, the method comprising:
(i) bonding a polymeric material (B) to a polymeric material (A); and
(ii) bonding the polymeric material (A) to a metal;
wherein the polymeric material (A) has a repeat unit of formula I:

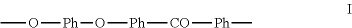

and a repeat unit of formula II:

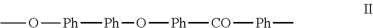

wherein Ph represents a phenylene moiety, and
wherein the polymeric material (B) has a repeat unit of formula I:

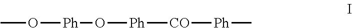

and does not comprise a repeat unit of formula II:

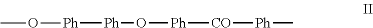

wherein Ph represents a phenylene moiety.

The component formed by the method of this fifth aspect is suitably a component of an assembly for handling, transporting or storing hydrogen. The component is suitably intended to come into contact with hydrogen, such as compressed hydrogen or liquid hydrogen, in use. Suitably the component is a hydrogen-contacting component, as described in relation to the first aspect.

The component, the polymeric material (A), the polymeric material (B), and the metal may have any of the suitable features or advantages described in relation to the first aspect.

The polymeric material (A), the polymeric material (B), and the metal may each be in the form of a layer. The component may be a pipe or storage vessel comprising a layer comprising the polymeric material (A), a layer comprising the polymeric material (B), and a layer comprising the metal.

Step (i) may comprise extruding the polymeric material (A) and the polymeric material (B). The polymeric material (A) and the polymeric material (B) may be extruded separately or coextruded. When the polymeric material (A) and the polymeric material (B) are extruded separately, they are suitably bonded together by lamination. When the polymeric material (A) and the polymeric material (B) are coextruded, the coextrusion process causes the polymeric material (A) and the polymeric material (B) to be bonded together. A separate bonding process is suitably not required.

Step (i) suitably comprises leaving at least a portion of the polymeric material (A) unbonded to the polymeric material (B). Preferably at least one surface of the layer comprising the polymeric material (A) is left unbonded to the layer comprising the polymeric material (B).

Step (i) is suitably followed by step (ii). The polymeric material (A) is suitably bonded to the polymeric material (B) before being bonded to the metal.

Preferably the polymeric material (B) is not bonded to the metal. Suitably, the layer comprising the polymeric material (A) is arranged between the layer comprising the polymeric material (B) and the layer comprising the metal.

The above assemblies can be made by any suitable means.

One method is the thermal lamination of polymeric material (A) to polymeric material (B) to the metal. This can be achieved by heating at least polymer (A) near or above its melting point, bringing polymeric material (A) into contact with polymeric material (B), and then bringing both polymeric material (A) and polymeric material (B) into contact with the metal (see FIGS. 8a,b,c).

Another method is to heat polymeric material (B) near or above its melting point, bringing polymeric material (B) into contact with polymeric material (A), and then bringing both polymeric material (A) and polymeric material (B) into contact with the metal (see FIGS. 8a,b,c).

A third method is to coextrude polymeric material (A) and polymeric (B) to form a multilayer article such as a film or sheet then applying the film or sheet to the metal, heating near or above the melting point of (A) to the metal (see FIGS. 8b,c).

A fourth method is to apply polymeric material (A) to the metal, apply polymeric material (B) to polymeric material (A) and then heat until the assembly is consolidated.

A fifth method is to apply polymeric material (A) to the metal and then heat until polymeric material (A) and the metal are consolidated, apply polymeric material (B) to polymeric material (A) and then heat until the assembly is consolidated (see FIGS. 9a,b,c).

For the above methods, it is understood that pressure is applied to ensure consolidation. Pressure can be varied as needed to achieve adhesion, minimize porosity, and minimize leakage. Pressure may be applied by any suitable means including the use of hydraulic, electromechanical, piezoelectric, weights, or other mechanical means. It is further understood that other support devices such as heaters, gasketing, sensors, transducers, controllers and other devices may be used to ensure the at the desired conditions (temperatures, pressure) are achieved and applied consistently.

Suitably, polymeric material (A) inner layer is thinner than the outer layer. The outer layer may have a thickness at least 2 times, such as at least 3 times, for example at least 4 times greater than the thickness of the polymeric material (A) inner layer. The polymeric material (A) inner layer may be a liner. Polymeric materials (A) and (B) may have a combined thickness of up to 5 mm, such as up to 4 mm, preferably up to 3 mm. In such embodiments, the polymeric material (B) outer layer is suitably a hydrogen-contacting layer.

The assembly may comprise an outer layer comprising the polymeric material (B) and an inner layer comprising the further polymeric material (A) and/or composite material and/or the metal. Suitably, the inner layer is thinner than the outer layer. The outer layer may have a thickness at least 2 times, such as at least 3 times, for example at least 4 times greater than the thickness of the inner layer. The inner layer may be a liner. The liner may have a thickness of up to 5 mm, such as up to 4 mm, preferably up to 3 mm.

The assembly may be used as bearing or a subassembly in a bearing. Suitable types of bearings include thrust bearings, roller bearings, linear bearings, plain bearings, cylindrical bearing, fluid film bearings and others.

Any feature of any aspect of any invention or embodiment described herein may be combined with any feature of any other invention described herein mutatis mutandis.

### BRIEF DESCRIPTION OF THE DRAWINGS

Specific embodiments of the invention will now be described, by way of example, with reference to the accompanying figures, in which:

FIG. 1 is a schematic cross section view of a pipe 10 for use in an assembly for handling, transporting or storing hydrogen according to the first aspect of the present invention.

FIG. 2 is a schematic cross section view of a pipe 20 for use in an assembly for handling, transporting or storing hydrogen according to the first aspect of the present invention.

FIG. 3 is a schematic cross section view of a pipe 30 for use in an assembly for handling, transporting or storing hydrogen according to the first aspect of the present invention.

FIG. 4 is a schematic cross section view of a pipe 40 for use in an assembly for handling, transporting or storing hydrogen according to the first aspect of the present invention.

FIG. 5 shows a schematic cross section view of an umbilical 50 for use in an assembly for handling, transporting or storing hydrogen according to the first aspect of the present invention.

FIG. 6 shows a perspective view of a valve seat 60 for use in an assembly for handling, transporting or storing hydrogen according to the first aspect of the present invention.

FIG. 7 shows a perspective view and schematic cross section view of a component 70 for use in an assembly for handling, transporting or storing hydrogen according to the first aspect of the present invention.

FIG. 8 shows a scheme 80a for a general method for making the component of FIG. 7.

FIG. 9 shows a scheme 80b for a general method for making the component of FIG. 7.

FIG. 10 provides results of elongation at break of a PEEK-PEDEK polymer and PCTFE at cryogenic temperatures.

### DETAILED DESCRIPTION OF THE EXAMPLE EMBODIMENTS

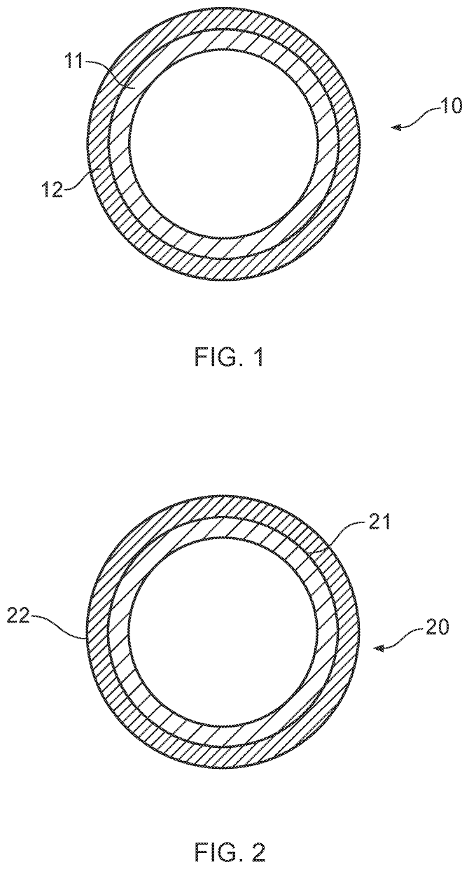

FIG. 1 shows a pipe 10 in cross section, the pipe 10 comprising an inner layer 11 and an outer layer 12. The inner layer 11 is formed of a polymeric material (A) as claimed herein, such as a 75:25 PEEK:PEDEK copolymer. The thickness of the inner layer 11 is around 3 mm or less. The outer layer 12 is formed of a different polymeric material to inner layer 11, for example a composite PEEK polymer. The outer layer 12 may have a CTE of around 0 ppm/K. The inner layer 11 is exposed to and contacts liquid hydrogen in use at temperatures of below −200° C. and a pressure from 10 to 100 MPa. The polymeric material (A) of the inner layer 11 provides a favourable tensile strength and tensile modulus and a high elongation at break when exposed to such temperatures. The outer layer 12 provides bulk structural integrity to the pipe 10. The pipe 10 can therefore be effectively used in an assembly for handling, transporting or storing hydrogen and outperform current pipes in such assemblies, when exposed to liquid hydrogen at temperatures of below −200° C. The pipe may be formed by co-extruding the inner layer 11 and the outer layer 12. Alternatively, the outer layer 12 may be applied, for example by lamination, to an extruded inner layer 11.

A liquid hydrogen storage vessel may have the same structure described above for pipe 10 and perform in a similarly advantageous manner.

FIG. 2 shows a pipe 20 in cross section, the pipe comprising an inner layer 21 and an outer layer 22. The inner layer 21 is formed of a polymeric material (A) as described above in relation to FIG. 1. The thickness of the inner layer 21 is around 3 mm of less. The inner layer 11 is exposed to and contacts liquid hydrogen in use at temperatures of below −200° C. and a pressure from 10 to 100 MPa. The outer layer 22 is provided by a high strength alloy material, such as 304 stainless steel. The outer layer 22 may be provided with a mechanism which allows for differential thermal expansion of the inner layer 21 and the outer layer 22. For example, the outer layer 22 may be corrugated.

High strength alloy materials, such as 304 stainless steel, are often susceptible to embrittlement on exposure to hydrogen which limits their usefulness in liquid hydrogen handling and storage assemblies. The pipe 20 advantageously provides an inner layer 21 which has very low permeability to hydrogen and therefore forms a protective barrier for the outer layer 22 to enable such high strength alloys to be effectively used in liquid hydrogen handling and storage assemblies. The inner layer 21 also provides the required tensile strength and tensile modulus, and provides an exceptionally high elongation at break when exposed to such temperatures, as described in relation to FIG. 1. Therefore the pipe 20 can be effectively used in an assembly for handling, transporting or storing hydrogen and outperform current pipes, such as all metal multilayer pipes, in such assemblies, when exposed to liquid hydrogen at temperatures of below −200° C. The pipe 20 may also have an advantageously lower weight than current all metal pipes used in such assemblies.

A liquid hydrogen storage vessel may have the same structure described above for pipe 20 and perform in a similarly advantageous manner.

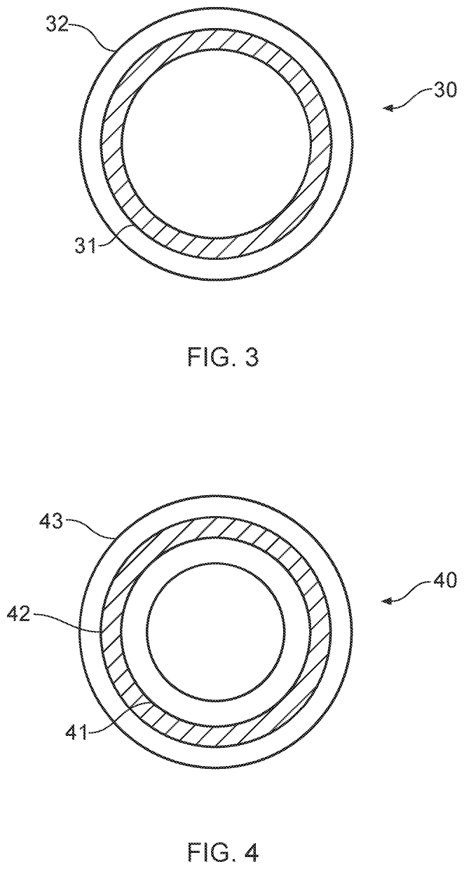

FIG. 3 shows a pipe 30 in cross section, the pipe comprising an inner layer 31 and an outer layer 32. The inner layer 31 is formed of a relatively thin layer of metal which has a low permeability to hydrogen (1×10⁻¹¹ to 1×10⁻²¹ cm³ cm/cm² s mmHg), such as aluminium or copper and has a relatively low tendency to suffer from hydrogen embrittlement, but may have a relatively low strength compared to alloys such as 304 stainless steel. This inner layer 31 is exposed to and contacts liquid hydrogen in use at temperatures of below −200° C. The outer layer 32 is formed of polymeric material (A). The outer layer 32 may additionally comprise a filler material to increase the strength of the outer layer, such as a fibre-reinforced unidirectional tape (UD tape). Suitable UD tapes are known in the art. The pipe 30 may be formed by extruding the outer layer 32 onto the inner layer metal pipe 31 and/or by welding a suitable UD tape with polymeric material (A) to the metal pipe of the inner layer 31. In use, the outer layer 32 is not directly exposed to liquid hydrogen. However, the outer layer 32 will experience the temperatures of below −200° C. and pressures of from 10 to 100 MPa which are typical in the storage and handling of liquid hydrogen.

In pipe 30, the inner layer metal pipe 31 provides an effective barrier to hydrogen permeation and is not affected by hydrogen embrittlement. The outer layer 32 comprising polymeric material (A) provides the bulk of the pipe 30 and provides the advantageous tensile strength, tensile modulus and especially high elongation at break when exposed to temperatures of less than −200° C. and pressures of from 10 to 100 MPa, as described in relation to FIG. 1. Therefore the pipe 30 can be effectively used in an assembly for handling, transporting or storing hydrogen and outperform current pipes, such as all metal multilayer pipes, in such assemblies, when exposed to liquid hydrogen at temperatures of below −200° C. The pipe 30 may also have an advantageously lower weight than current all metal pipes used in such assemblies.

A liquid hydrogen storage vessel may have the same structure described above for pipe 30 and perform in a similarly advantageous manner.

In an embodiment of FIG. 4 a pipe 40 in cross section is shown, the pipe 40 comprising inner 41 and outer layers 43 and core layer 42. The inner layer 41 and outer layer 43 are formed of a polymeric material (A), as described above in relation to FIG. 1. The inner layer 41 is exposed to and contacts liquid hydrogen in use at temperatures of below −200° C. and a pressure from 10 to 100 MPa. The outer layer 43 is not intended to contact liquid hydrogen but is intended to experience such temperatures and pressures in use. The polymeric material of the inner 41 and outer 43 layers provides a high tensile strength, tensile modulus and elongation at break when exposed to such temperatures. The outer layer 43 and/or inner layer 41 may additionally comprise a filler material to increase the strength of the outer layer, such as a fibre-reinforced unidirectional tape (UD tape).

Suitable UD tapes are known in the art.

The core layer 42 is formed of a relatively thin layer of metal which has a relatively low permeability to hydrogen (1×10⁻¹¹ to 1×10⁻²¹ cm³ cm/cm² s mmHg), such as aluminium or copper, and which may have a relatively low strength compared to alloys such as 304 stainless steel. Therefore the core layer 42 provides an effective barrier layer against hydrogen permeation and the relative weakness of the core layer 42 is compensated for by the inner and outer layer 41 of polymer material (A) which provides excellent mechanical properties at low temperatures, as discussed above. This configuration may minimise the amount of metal that needs to be used in the core layer 42 of the pipe 40, reducing the cost and weight of the pipe 40 compared to current pipes used in hydrogen storage and handling which require thicker layers of such metals or further strengthening with different metal layers in a multi-layer metal pipe. This configuration may also provide improved performance compared to current pipes formed of polymeric material due to the mechanical properties at extreme low temperatures provided by the polymeric material (A) of the inner and outer layers 41 and the improved hydrogen barrier properties provided by the thin metal core layer 42. The pipe 40 may therefore be advantageous in an assembly for handling, transporting or storing hydrogen and outperform current pipes, such as all metal multilayer pipes, in such assemblies, when exposed to liquid hydrogen at temperatures of below −200° C.

The pipe 40 may be formed by co-extruding or welding the inner and outer layers 41 onto the core layer 42.

A liquid hydrogen storage vessel may have the same structure described above for pipe 40 and perform in a similarly advantageous manner.

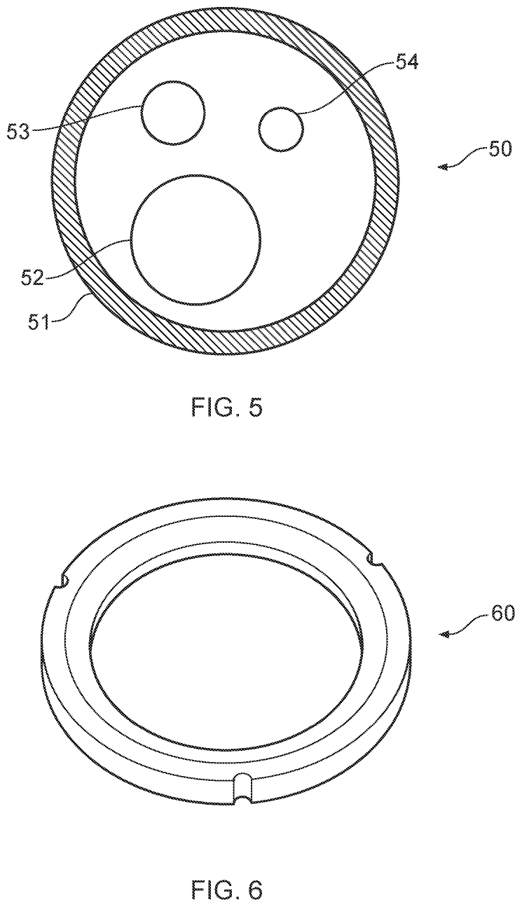

FIG. 5 shows an umbilical 50 in cross section, the umbilical comprising a sheath 51 and conduits: a hydrogen transmission pipe 52, an electrical cable 53 and a fibre optic cable 54. The sheath 51 is formed of a polymeric material (A), as described above in relation to FIG. 1. The hydrogen transmission pipe 52 is exposed to and contacts liquid hydrogen in use at temperatures of below −200° C. and a pressure from 10 to 100 MPa. The sheath 51 is not intended to contact liquid hydrogen but is intended to experience such temperatures and pressures in use. The polymeric material of the sheath 51 provides a high tensile strength, tensile modulus and an especially high elongation at break when exposed to such temperatures. In addition to the hydrogen transmission pipe 52, the electrical cable 53 and the fibre optic cable 54, further conduits may be present. The umbilical 50 makes it easier to handle the conduits 52, 53, 54 therein. Since polymeric material (A) is transparent to much of the electromagnetic spectrum, the flow of hydrogen through the transmission pipe 52 can advantageously be monitored from outside the umbilical sheath 51. In some embodiments, sensors and/or transducers may be incorporated in the sheath 51 (not shown), for example during melt processing of the polymeric material (A).

FIG. 6 shows a valve seat 60 in perspective view. The valve seat 60 is formed of a polymeric material (A), as described above in relation to FIG. 1. Polymeric material (A) has excellent tensile properties at cryogenic temperatures, such as below −253° C., while providing dimensional stability to the valve seat 60 over a wide temperature range. Compared to fluoropolymers such as PCTFE which may be used to form valve seats, polymeric material (A) achieves an improved elongation at break at such low temperatures whilst maintaining a similar, favourable tensile modulus and tensile strength. Furthermore, polymeric material (A) may advantageously provide lubricity and low hydrogen permeability to the valve seat 60, thereby reducing hydrogen embrittlement of adjacent metal components. Other components described herein such as piston rings, piston rod rings, or impellers may suitably be formed from polymeric material (A) to take advantage of the properties described above, which are particularly desirable for moving and/or load-bearing components.

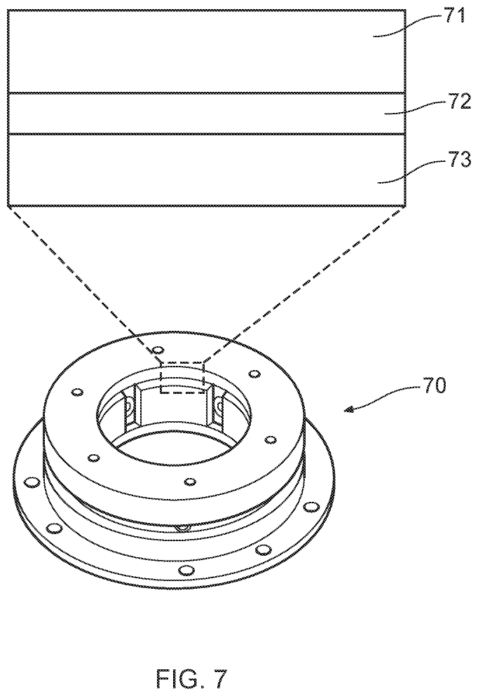

FIG. 7 shows a component 70 with an enlarged schematic cross-section thereof. The component has a PEEK layer 71, a PEEK-PEDEK copolymer layer 72, a steel layer 73. The PEEK layer 71 may be provided by a PEEK polymer such as VICTREX CT™ 100, available from Victrex Manufacturing Limited, which is a polymeric material (B) according to the description above. There is a considerable difference between the coefficient of thermal expansion (CTE) of the PEEK layer 71 and the steel layer 73. This means that if the PEEK layer 71 and the steel layer 73 are bonded directly together, they are susceptible to interfacial stress at very low temperatures. This can cause failure or disbondment of the component 70. The PEEK-PEDEK copolymer advantageously provides a stress-reducing layer 72 between the PEEK layer 71 and the steel layer 73, by bonding to both the PEEK layer 71 the steel layer 73 and therefore avoiding the PEEK layer 71 and the steel layer 73 contacting each other and causing the potential problems discussed above. The PEEK-PEDEK layer 72 (polymeric material (A)) is compatible with both the PEEK layer 71 and the steel layer 73 and forms strong bonds with both. Therefore the component may provide the benefits having the PEEK layer 71 and the steel layer 73 without risking the component failing due to disbondment of the PEEK layer 71 from the steel layer 73, due to the presence of the PEEK-PEDEK copolymer layer 72.

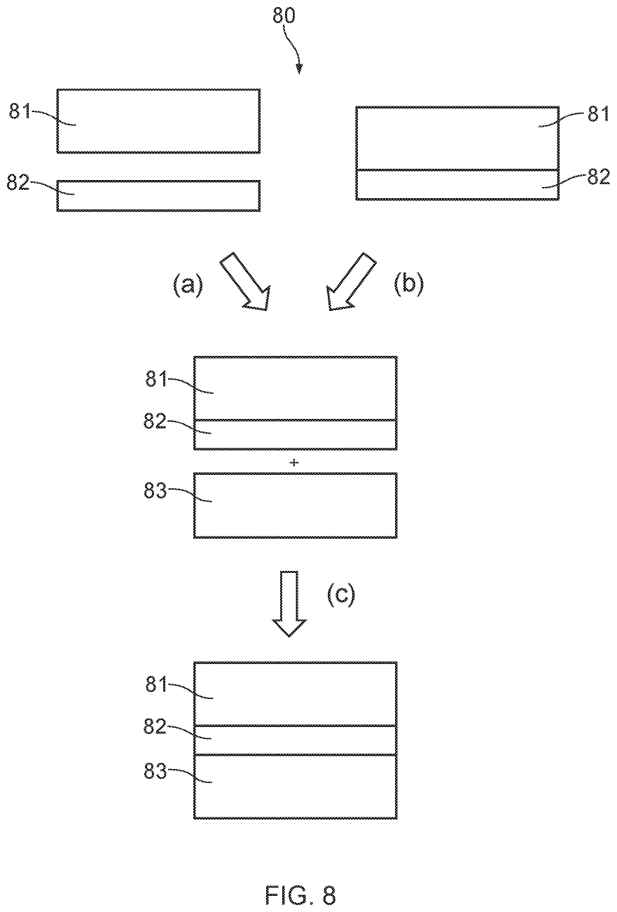

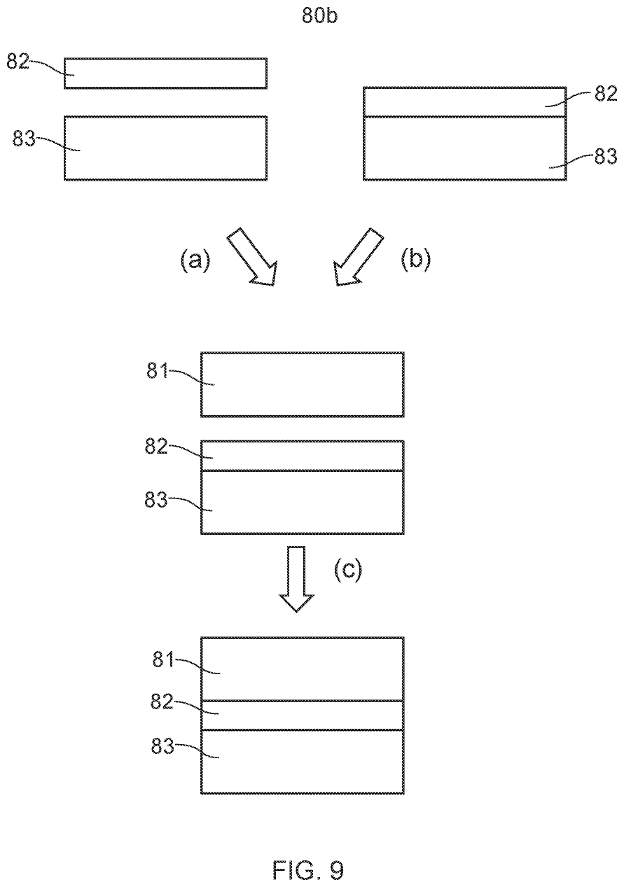

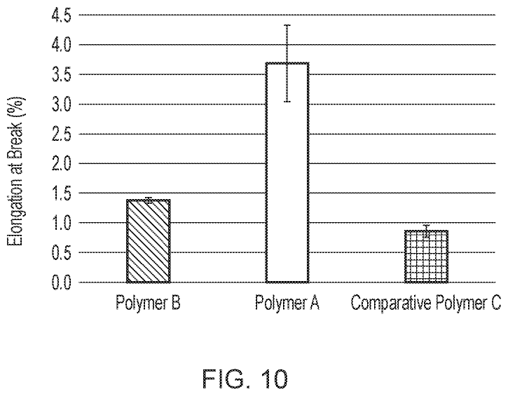

FIG. 8 shows a general method for making the component 70 of FIG. 7. The PEEK layer 81 and the PEEK-PEDEK copolymer layer 82 are bonded together either by (a) separately extruding and then laminating the PEEK layer 81 and the PEEK-PEDEK copolymer layer 82, or (b) coextruding the PEEK layer 81 and the PEEK-PEDEK copolymer layer 82. The bonded PEEK layer 81 and PEEK-PEDEK copolymer layer 82 are then (c) bonded to the steel layer 83.

### EXAMPLES—TENSILE TESTS

The following materials were subjected to tensile testing to compare their performance in relation to use at cryogenic temperatures in the handling, transporting or storing of liquid hydrogen.

Polymer A—a PEEK-PEDEK copolymer (a polymeric material (A) according to the definition above) with PEEK:PEDEK ratio of 75:25. This polymer has a MV of 0.31 kNsm⁻² when measured as described above.

Polymer B: VICTREX CT™ 100—PEEK polymer (a polymeric material (B) according to the definition above) which is commercially available from Victrex Manufacturing Limited, Thornton Cleveleys, UK. This polymer has a MV of 0.65 kNsm⁻² when measured as described above.

Comparative Polymer C: PCTFE (polychlorotrifluoroethylene)—a chlorofluoropolymer commonly used for low temperature applications commercially available from Daikin Industries Ltd. PCTFE is sold under the tradename Neoflon®.

Tensile tests according to ISO 527-1:2019 were carried out with liquid helium temperatures at −269° C.

Results for tensile strength, tensile modulus, and elongation at break for Polymer A, Polymer B and Comparative Polymer C at −269° C. are provided in Table 1 below.

TABLE 1

| | | | | | Comparative | |
|---|---|---|---|---|---|---|
| | Polymer B | | Polymer A | | Polymer C | |
| | | ST Dev | | ST DEV | | ST DEV |
| Tensile Strength | 208.6 | ±5.86 | 130.6 | ±6.11 | 142.8 | ±12.40 |
| (MPa) | | | | | | |
| Youngs Modulus | 5.9 | ±0.14 | 3.6 | ±0.08 | 6.0 | ±0.62 |
| (GPa) | | | | | | |
| Elongation at | 1.4 | ±0.05 | 3.7 | ±0.64 | 0.9 | ±0.10 |
| Break (%) | | | | | | |

The results for Polymer A (of the present invention) showed acceptable tensile strength and tensile modulus for the desired applications at −269° C., which were comparable to the values obtained to the Comparative Polymer C (PCTFE). The results also show Polymer A to have a far superior elongation at break than the Comparative Polymer C material and the PEEK polymer (Polymer B), which may provide improved performance in components and assemblies for the handling, transporting or storing liquid hydrogen, especially wherein the component is required to tolerate high loads and withstand some plastic deformation without breakage, in use at cryogenic temperatures.

In the present specification, the term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to components, a component consisting essentially of a polymeric material will comprise less than 5% by weight, typically less than 3% by weight, more typically less than 1% by weight of non-specified materials.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An assembly for handling, transporting storing hydrogen, wherein the assembly comprises a component comprising a polymeric material (A) having a repeat unit of formula I: 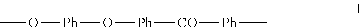
and a repeat unit of formula II: 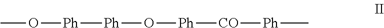
wherein Ph represents a phenylene moiety.

2. The assembly of claim 1, wherein the assembly is subjected to a temperature of less than −200° C. in use.

3. The assembly of claim 1, wherein the component is selected from the group comprising a seal, a valve, a part of a valve, a gasket, a bearing, a part of a bearing, a housing, a ring, an impeller, a storage vessel, a part of a storage vessel, a pipe, a part of a pipe, a pipe liner, a connector, insulation, for example for wire or cable, a bush, an umbilical, and a part of an umbilical.

4. The assembly of claim 3, wherein the component is a piston ring, a piston rod ring, or an impeller.

5. The assembly of claim 3, wherein the component is an umbilical or a part of an umbilical.

6. The assembly of claim 1, wherein the component comprises a sensor and/or a transducer.

7. The assembly of claim 1, wherein the component further comprises a composite material and/or a metal.

8. The assembly of claim 7, wherein the polymeric material (A) is bonded to the composite material and/or the metal.

9. The assembly of claim 7, wherein the component is a pipe or storage vessel comprising a layer comprising the polymeric material (A) and a layer comprising the composite material and/or the metal.

10. The assembly of claim 9, wherein the pipe or storage vessel comprises an inner layer comprising the polymeric material (A) and an outer layer comprising the composite material and/or the metal.

11. The assembly of claim 9, wherein the pipe or storage vessel comprises an outer layer comprising the polymeric material (A) and an inner layer comprising the composite material and/or the metal.

12. The assembly of claim 9, wherein the pipe or storage vessel comprises at least two layers comprising the polymeric material (A) and at least one layer comprising the composite material and/or the metal.

13. The assembly of any preceding claim 1, wherein, in the polymeric material (A), the repeat unit of formula I has the structure Ia: 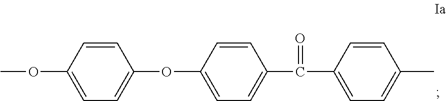
and
the repeat unit of formula II has the structure IIa:

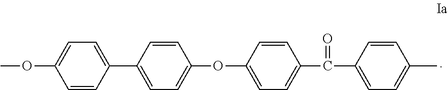

14. The assembly of claim 1, wherein the polymeric material (A) comprises at least 68 mol % of repeat units of formula I and at least 10 mol % of repeat units of formula II.

15. The assembly of claim 1, wherein the polymeric material (A) has a melt viscosity of up to 1.8 kNsm⁻².

16. The assembly of claim 1, wherein the polymeric material (A) has a melt viscosity of at least 0.06 kNsm⁻².

17.-20. (canceled)

21. A method of handling, transporting or storing hydrogen, the method comprising:
(i) providing a component in an assembly for handling, transporting or storing hydrogen, wherein the component comprises a polymeric material (A) having a repeat unit of formula I: 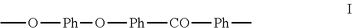
and a repeat unit of formula II: 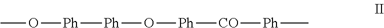
wherein Ph represents a phenylene moiety, and
(ii) contacting the assembly with hydrogen so as to handle, transport or store the hydrogen.

22. A component comprising a polymeric material (A), a polymeric material (B), and a metal, wherein the polymeric material (A) is bonded to the metal and to the polymeric material (B);
wherein the polymeric material (A) has a repeat unit of formula I: 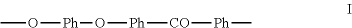
and a repeat unit of formula II: 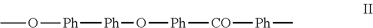
wherein Ph represents a phenylene moiety, and
wherein the polymeric material (B) has a repeat unit of formula I: 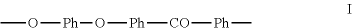
and does not comprise a repeat unit of formula II: 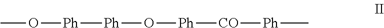
wherein Ph represents a phenylene moiety.

23. (canceled)

24. The assembly of claim 2, wherein the assembly is subjected to a temperature in the range of −260° C. to −200° C. in use.

25. The assembly of claim 5, wherein the component is an umbilical sheath.
